(19) United States
(12) Patent Application Publication
(10) Pub. No.: US 2014/0006375 A1
(43) Pub. Date: Jan. 2, 2014

(54) METHOD AND APPARATUS FOR ROBUST MOBILE APPLICATION FINGERPRINTING

(71) Applicants: Andrea G. Forte, Brooklyn, NY (US); Baris Coskun, Weehawken, NJ (US); Qi Shen, New York, NY (US); Ilona Murynets, Rutherford, NJ (US); Jeffrey Bickford, Somerset, NJ (US); Mikhail Istomin, Brooklyn, NY (US); Paul Giura, Cairo, NY (US); Roger Piqueras Jover, New York, NY (US); Ramesh Subbaraman, Jersey City, NJ (US); Suhas Mathur, Bayonne, NJ (US); Wei Wang, Hoboken, NJ (US)

(72) Inventors: Andrea G. Forte, Brooklyn, NY (US); Baris Coskun, Weehawken, NJ (US); Qi Shen, New York, NY (US); Ilona Murynets, Rutherford, NJ (US); Jeffrey Bickford, Somerset, NJ (US); Mikhail Istomin, Brooklyn, NY (US); Paul Giura, Cairo, NY (US); Roger Piqueras Jover, New York, NY (US); Ramesh Subbaraman, Jersey City, NJ (US); Suhas Mathur, Bayonne, NJ (US); Wei Wang, Hoboken, NJ (US)

(21) Appl. No.: 13/540,307

(22) Filed: Jul. 2, 2012

(51) Int. Cl. G06F 17/30

(52) U.S. Cl. 707/709; 707/758; 707/722; 707/E17.108

(57) ABSTRACT

A method, non-transitory computer readable medium and apparatus for fingerprinting applications are disclosed. For example, the method analyzes an application binary of the application, extracts an invariant feature from the application binary, generates a signature from the invariant feature, and compares the signature of the application to a second signature of a second application to determine if the application and the second application are similar.

The present disclosure relates generally to applications and, more particularly, to a method and apparatus for fingerprinting a software application.

### BACKGROUND

Mobile endpoint device use has increased in popularity in the past few years. Associated with the mobile endpoint devices are the proliferation of software applications (broadly known as “apps” or “applications”) that are created for the mobile endpoint device.

The number of available apps is growing at an alarming rate. Currently, hundreds of thousands of apps are available to users via app stores such as Apple's® app store and Google's® Android marketplace. In addition, there is minimal control as to which versions of the apps are available or if the provided description accurately describes the app.

As a result, when a user performs a search for an app, the search result may include duplicates of varying versions of the same app that match the search and may dominate the search result. Alternatively, the search result may include apps that include information to match popular searches, but do not accurately describe the app.

### SUMMARY

In one embodiment, the present disclosure provides a method for fingerprinting applications. For example, the method analyzes an application binary of the application, extracts an invariant feature from the application binary, generates a signature from the invariant feature, and compares the signature of the application to a second signature of a second application to determine if the application and the second application are similar.

### BRIEF DESCRIPTION OF THE DRAWINGS

The present disclosure can be readily understood by considering the following detailed description in conjunction with the accompanying drawings, in which:

FIG. 1 illustrates one example of a communications network of the present disclosure;

FIG. 2 illustrates an example functional framework flow diagram for app searching;

FIG. 3 illustrates an example flowchart of one embodiment of a method for fingerprinting an app; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, non-transitory computer readable medium and apparatus for fingerprinting software applications (“apps”). The growing popularity of apps for mobile endpoint devices has lead to an explosion of the number of apps that are available. Currently, there are hundreds of thousands of apps available for mobile endpoint devices.

However, different versions of the same app are constantly being created. As a result, if a user submits a search for an app, the search result may be dominated by slightly different versions of the same app. In addition, the filename and meta-data of the app may not be reliable for comparing purposes. For example, a developer may provide a completely different filename and meta-data for slightly different versions or an updated version of the same app. One embodiment of the present disclosure fingerprints apps such that multiple versions of the same app, or the same apps that are named differently, are grouped together.

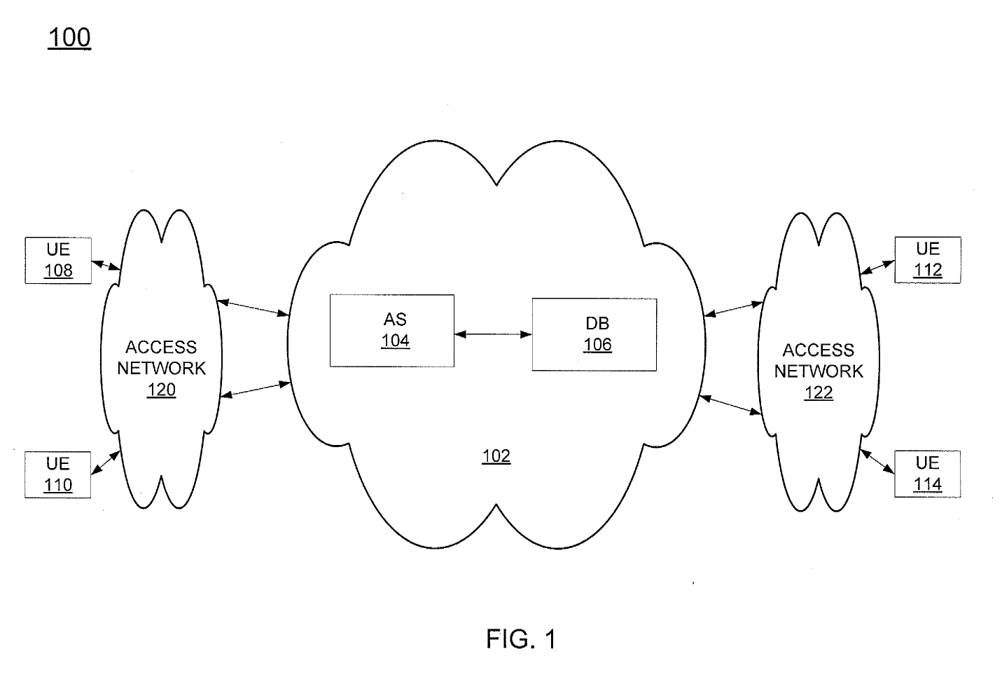

FIG. 1 is a block diagram depicting one example of a communications network 100. The communications network 100 may be any type of communications network, such as for example, a traditional circuit switched network (e.g., a public switched telephone network (PSTN)) or a packet network such as an Internet Protocol (IP) network (e.g., an IP Multimedia Subsystem (IMS) network, an asynchronous transfer mode (ATM) network, a wireless network, a cellular network (e.g., 2G, 3G and the like), a long term evolution (LTE) network, and the like) related to the current disclosure. It should be noted that an IP network is broadly defined as a network that uses Internet Protocol to exchange data packets. Additional exemplary IP networks include Voice over IP (VoIP) networks, Service over IP (SoIP) networks, and the like. It should be noted that the present disclosure is not limited by the underlying network that is used to support the various embodiments of the present disclosure.

In one embodiment, the network 100 may comprise a core network 102. The core network 102 may be in communication with one or more access networks 120 and 122. The access networks 120 and 122 may include a wireless access network (e.g., a WiFi network and the like), a cellular access network, a PSTN access network, a cable access network, a wired access network and the like. In one embodiment, the access networks 120 and 122 may all be different types of access networks, may all be the same type of access network, or some access networks may be the same type of access network and other may be different types of access networks. The core network 102 and the access networks 120 and 122 may be operated by different service providers, the same service provider or a combination thereof.

In one embodiment, the core network 102 may include an application server (AS) 104 and a database (DB) 106. Although only a single AS 104 and a single DB 106 are illustrated, it should be noted that any number of application servers 104 or databases 106 may be deployed.

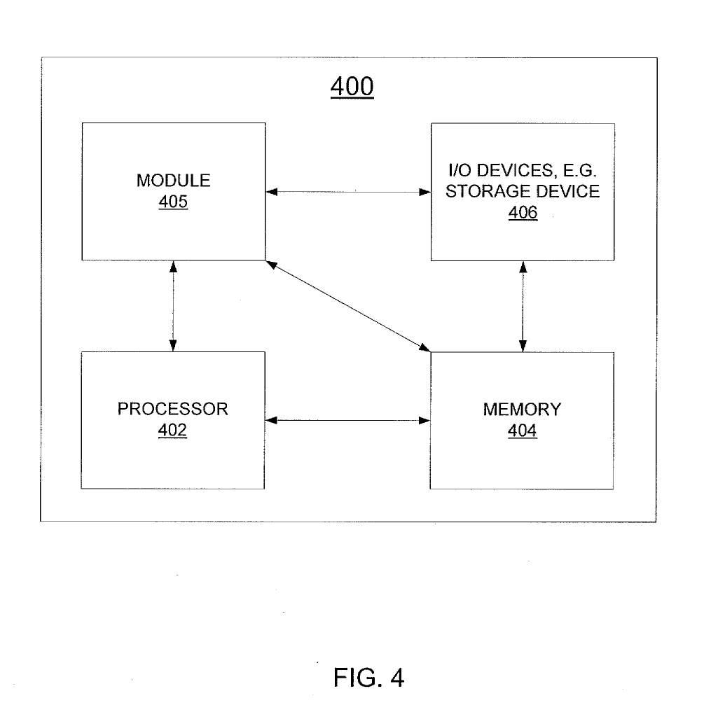

In one embodiment, the AS 104 may comprise a general purpose computer as illustrated in FIG. 4 and discussed below. In one embodiment, the AS 104 may perform the methods and algorithms discussed below related to fingerprinting apps.

In one embodiment, the DB 106 may store various app binaries that are collected by a web crawler. In addition, the DB 106 may store the signatures that are generated based upon the app binaries for each one of the apps that are analyzed. The app binaries and generation of signatures are discussed in further detail below.

In one embodiment, the DB 106 may store various information related to apps. For example, as meta-data is extracted from the apps, the meta-data may be stored in the DB 106. The meta-data may include information such as a type of app, a developer of the app, app keywords and the like. The meta-data may then be used to search the Internet for additional information about the app, such as a reputation of the developer for creating the type of app being analyzed and the like. The additional information obtained from searching the Internet may also be stored in the DB106.

In one embodiment, the DB 106 may also store a plurality of apps that may be accessed by users via their endpoint device. In one embodiment, a plurality of databases 106 storing a plurality of apps may be deployed, e.g., a database for storing game apps, a database for storing productivity apps such as word processor apps and spreadsheet apps, a database for storing apps for a particular vendor or for a particular software developer, a database for storing apps to support a particular geographic region, e.g., the east coast of the US or the west coast of the US, and so on. In one embodiment, the databases may be co-located or located remotely from one another throughout the communications network 100. In one embodiment, the plurality of databases may be operated by different vendors or service providers. Although only a single AS 104 and a single DB 106 are illustrated in FIG. 1, it should be noted that any number of application servers or databases may be deployed.

In one embodiment, the access network 120 may be in communication with one or more user endpoint devices (also referred to as “endpoint devices” or “UE”) 108 and 110. In one embodiment, the access network 122 may be in communication with one or more user endpoint devices 112 and 114.

In one embodiment, the user endpoint devices 108, 110, 112 and 114 may be any type of endpoint device such as a desktop computer or a mobile endpoint device such as a cellular telephone, a smart phone, a tablet computer, a laptop computer, a netbook, an ultrabook, a tablet computer, a portable media device (e.g., an iPod® touch or MP3 player), and the like. It should be noted that although only four user endpoint devices are illustrated in FIG. 1, any number of user endpoint devices may be deployed.

It should be noted that the network 100 has been simplified. For example, the network 100 may include other network elements (not shown) such as border elements, routers, switches, policy servers, gateways, firewalls, various application servers, security devices, a content distribution network (CDN) and the like.

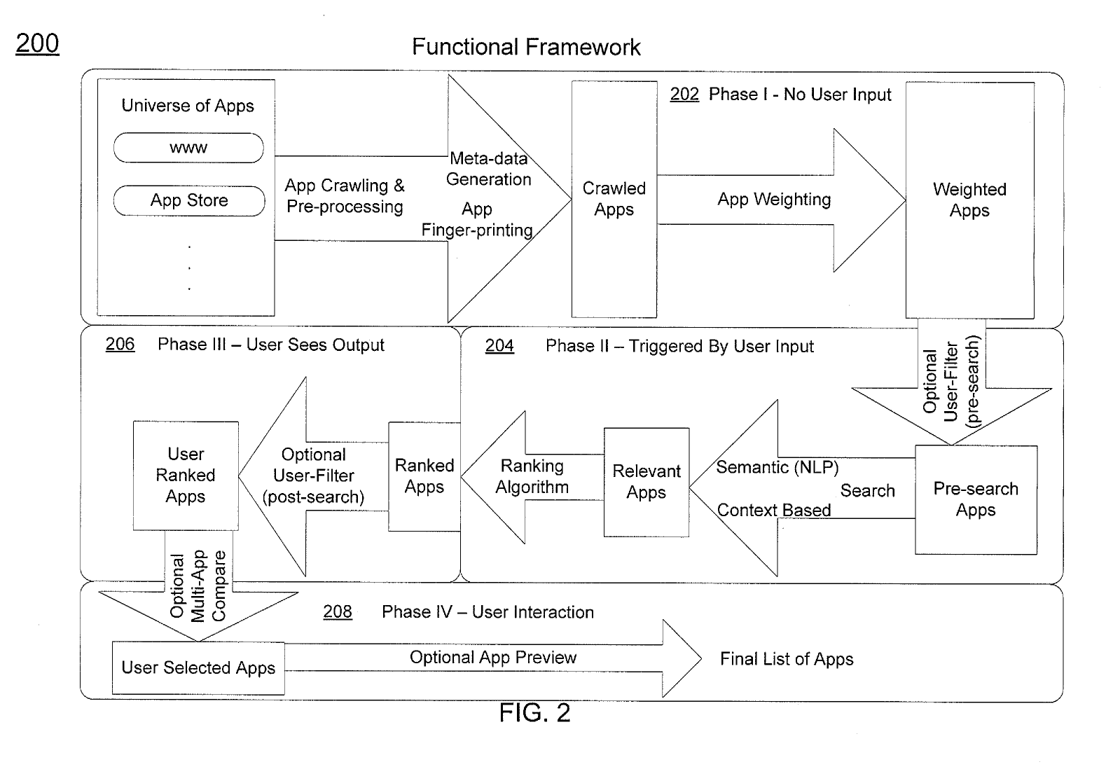

FIG. 2 illustrates an example of a functional framework flow diagram 200 for app searching. In one embodiment, the functional framework flow diagram 200 may be executed for example, in a communication network described in FIG. 1 above.

In one embodiment, the functional framework flow diagram 200 includes four different phases, phase I 202, phase II 204, phase III 206 and phase IV 208. In phase I 202, operations are performed without user input. For example, from a universe of apps, phase I 202 may pre-process each one of the apps to obtain and/or generate meta-data and perform app fingerprinting to generate a “crawled app.” Apps may be located in a variety of online locations, for example, an app store, an online retailer, an app marketplace or individual app developers who provide their apps via the Internet, e.g., websites.

In one embodiment, a web crawler may be used to obtain various apps and the app binaries for each one of the apps. App binaries provide a digital representation of the app. For example, the app binary may be a string of zeros and ones. Unlike, meta-data that can be modified by a developer to include any terms or information that they would like, app binaries represent the executable binary code of the app that cannot be “forged” like meta-data. As a result, unlike meta-data and file names that may not be reliable in accurately describing the app, the app binary may be trusted as an accurate description of the app. For example, an app may actually be a malicious computer virus that is disguised as an innocuous app by the developer by providing inaccurate meta-data and file names. However, the app binary can be analyzed to see that the app is a malicious computer virus and not what the meta-data or file name describes it to be.

As noted above, an app may have multiple versions released as apps are upgraded, modified to fix bugs, implemented with new features, and the like. Each version of the same app may have different app binaries. As a result, simply comparing the app binaries may not be sufficient to identify two apps as being similar or different versions of the same app.

However, a substantial portion of the app may still remain the same. That is, some features across all versions of the same app may not change or may be considered to be invariant. Some examples of invariant features in an app may include program based features and multimedia based features.

In one embodiment, program based features may include, for example, call graphs and memory layouts. For example, a significant portion of the software codes may be reused between versions of the same app. Any methodology may be used for identifying the invariant program features in the app binary may be used.

In one embodiment, the multimedia based features may include, for example, video, music, sound effects, background images and the like. For example, typically different versions of the same app may recycle the same background images, video clips, background music and/or sound effects. Any methodology for detecting the invariant multimedia based features in the app binary may be used.

Once the invariant features of the app are extracted from the app binary, a signature may be generated for the app. In one embodiment, the signature may comprise a binary subset of the app binary. For example, the signature may be the binary subset that represents the invariant feature.

As a result, even though different versions of the same app may have completely different app binaries in different bit streams, the present disclosure allows for the detection of similar apps based upon the signatures. For example, a particular app may have certain invariant features such as a particular call graph or series of background images. These invariant features may be stored in the DB 106 as one or more signatures of the app.

Subsequently, if a particular app is updated to introduce a new feature, then the updated app can have its app binary analyzed to extract the invariant features and generate one or more signatures. The one or more signatures of the updated app may be compared to the one or more signatures of the previous version of the app to determine that they are related or similar.

For example, the DB 106 may store signatures for various apps that have been previously generated. Each one of a plurality of apps may have various signatures attached to that app and stored for future reference in the DB 106. As a result, the invariant features of the app may be extracted and the binary for the invariant feature may be compared against the signatures in the DB 106 of all the apps to see if there is a match. In one embodiment, if a substantial portion of the binary for the invariant feature matches the signature (e.g., greater than 90%), then it may be considered to be a match. It should be noted that the threshold (e.g., 90%) is only illustrative and should not be interpreted as a limitation, i.e., other thresholds can be used (e.g., 80%, 85%, 95% and so on).

In one embodiment, this process may be repeated for each invariant feature of the app. For example, if the app has a plurality of invariant features and if the binaries for the app's invariant features match substantially all of the signatures of a particular app, then the two apps may be considered to be the same or similar. In one embodiment, if the number of signatures that match are above a predetermined threshold (e.g., greater than 90%), then the two apps may be considered to be similar. In one embodiment, the similar apps may be grouped into a common group.

After the apps are fingerprinted, the apps may be weighted to assign an initial weighting that is used to compute an initial ranking. For example, at phase I 202, the method may optionally apply a weight to each application to generate a “weighted app.” For example, the weight can be applied in accordance with various parameters, e.g., a reputation of the app developer, a cost of app, the quality of the technical support provided by the developer, a size of the app (e.g., memory size requirement), ease of use of the app in general, ease of use based on the user interface, effectiveness of the app for its intended purpose, and so on. For example, a reputation of a developer for developing particular types of apps may optionally also be obtained, e.g., from a public online forum, from a social network website, from an independent evaluator, and so on. The reputation information implemented via weights may then be used to calculate an initial ranking for each one of the apps, e.g., a weight of greater than 1 can be applied to a developer with a good reputation, whereas a weight of less than 1 can be applied to a developer with a poor reputation. It should be noted that the weights (e.g., with a range of 1-10, with a range between 0-1, and so on) can be changed based on the requirements of a particular implementation.

An optional user based filtering step can be applied once the apps are weighted and an initial ranking for each of the apps is computed. For example, each user may have a predefined set of parameters that are to be applied to all of the apps, e.g., excluding all apps of a particular size due to hardware limitation, excluding all apps based on a cost of the apps, excluding all apps from a particular developer and so on. It should be noted that this step is only applied if the user has a predefined set of filter criteria to be applied to generate “pre-search apps”.

Once the apps are fingerprinted, weighted and/or ranked, phase II 204 is triggered by user input. For example, during phase II 204 a user may input a search query for a particular app. In one embodiment, the search may be based upon a natural language processing (NLP) or semantic query. For example, the search may simply be a search based upon matches of keywords provided by the user in the search query. Using the NLP query, a NLP ranking of the app may be computed.

In one embodiment, the search may be based upon a context based query. For example, the search may be performed based upon what (e.g., an activity the user is participating in), where (e.g., a location), when (e.g., a time of day) and with whom (e.g., a single user, a group of users, friends, family, an age of the user and the like) a user is performing an activity.

A ranking algorithm may be applied to the apps that accounts for at least the initial ranking and the context based ranking to compute a final ranking of the apps. In one embodiment, the final ranking may be calculated based upon the initial ranking, the context based ranking, the NLP ranking and/or a user feedback ranking. For example, the weight values of each of the rankings may be added together to compute a total weight value, which may then be compared to the total weight values of the other apps.

At phase III 206, the results of the final ranking are presented to the user. At this point, if the apps were not fingerprinted in phase I 202, one app may dominate the search results with multiple different versions of the same app. However, by fingerprinting the apps, different versions of the same app may be grouped together.

In one embodiment, the grouped apps may be presented to the user in a common tab that may be expandable or collapsed. For example, the app may be listed in a graphical user interface with a “+” tab indicating to the user that the result includes multiple versions. Thus, if a user is interested, the user may expand the tab by clicking on the “+” symbol and select any one of the versions of the apps they desire.

During phase III 206, the user may apply one or more optional post search filters to the ranked apps, e.g., various filtering criteria such as cost, hardware requirement, popularity of the app, other users' feedback, and so on. The post search filters may then be applied to the relevant ranked apps to generate a final set of apps that will be presented to the user.

At phase IV 208, the user may interact with the apps. For example, the user may select one of the apps and either preview the app or download the app for installation and execution on the user's endpoint device.

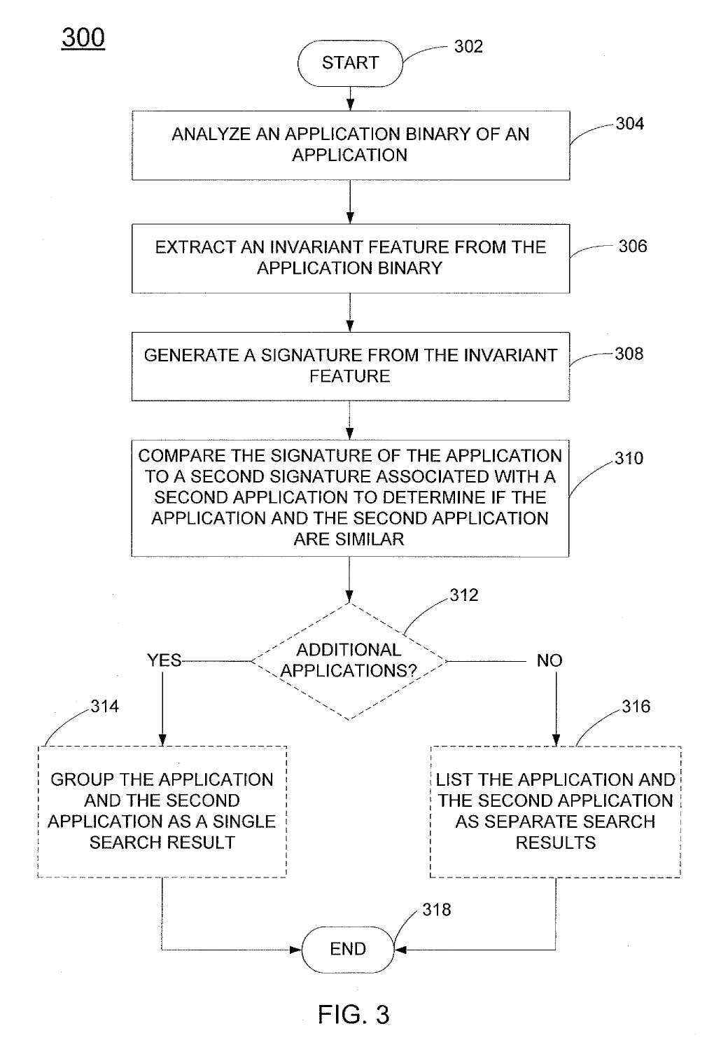

FIG. 3 illustrates a flowchart of a method 300 for app fingerprinting. In one embodiment, the method 300 may be performed by the AS 104 or a general purpose computing device as illustrated in FIG. 4 and discussed below.

The method 300 begins at step 302. At step 304, the method 300 analyzes an app binary of an app. For example, a web crawler may obtain apps and the respective app binaries from the Internet or World Wide Web. Apps may be located in a variety of online locations, for example, an app store, an online retailer, an app marketplace or individual app developers who provide their apps via the Internet, e.g., websites. An online location is broadly interpreted as a location accessible via a network connection. Thus, crawling “online” for an app is broadly interpreted as accessing an app via a network connection, e.g., accessing an app on a local area network (or server) or through the Internet where the app is located on an external network (or server).

At step 306, the method 300 extracts an invariant feature from the app binary. As discussed above, a substantial portion of the app may still remain the same. That is, some features across all versions of the same app may not change or may be considered to be invariant. Some examples of invariant features in an app may include program based features and multimedia based features.

In one embodiment, program based features may include, for example, call graphs and memory layouts. For example, a significant portion of the software codes may be reused between versions of the same app. Any methodology may be used for identifying the invariant program features in the app binary may be used.

In one embodiment, the multimedia based features may include, for example, video, music, sound effects, background images and the like. For example, typically different versions of the same app may recycle the same background images, video clips, background music and/or sound effects. Any methodology for detecting the invariant multimedia based features in the app binary may be used.

At step 308, the method 300 generates a signature (broadly one or more signatures) from the invariant feature. In one embodiment, the signature may comprise a binary subset of the app binary. For example, the signature may be the binary subset that represents the invariant feature.

At step 310, the method compares the signature of the app to a second signature associated with a second app to determine if the app and the second app are similar. For example, the DB 106 may store signatures for various apps that have been previously generated. Each one of a plurality of apps may have various signatures attached to that app and stored for future reference in the DB 106. As a result, the invariant features of the app may be extracted and the binary for the invariant feature may be compared against the signatures in the DB 106 of all the apps to see if there is a match. In one embodiment, if a substantial portion of the binary for the invariant feature matches the signature (e.g., greater than 90%), then it may be considered to be a match.

In one embodiment, this process may be repeated for each invariant feature of the app. For example, if the app has a plurality of invariant features and if the binaries for the app's invariant features match substantially all of the signatures of a particular app, then the two apps may be considered to be the same or similar. In one embodiment, if the number of signatures that match are above a predetermined threshold (e.g., greater than 90%), then the two apps may be considered to be similar. In one embodiment, the similar apps may be grouped into a common group.

The method 300 may then perform optional steps 312, 314 and 316. For example, the optional steps 312, 314 and 316 may be one application of how to use the information gathered from step 310.

For example, at step 312, the method 300 may determine if the apps are similar. If the apps are similar, the method 300 may proceed to step 314. At step 314, the method 300 groups the app and the second app as a single search result. For example, if a user submits a search query and both the app and the second app were to match the search query, the app and the second app would be grouped together and presented to the user as a single search result (e.g., as a single instance of the app). In one embodiment, the apps may be presented under a common tab that may be expandable and collapsible to allow the user to view the different versions if the user is looking to select a particular version of the app.

Referring back to step 312, if the method 300 determines that the apps are not similar, the method 300 may proceed to step 316. At step 316, the method 300 lists the app and the second app as separate search results. In other words, since the apps are not found to be similar, the app and the second app would appear as separate listings in the search result.

Either from step 314 or step 316, the method proceeds to step 318. At step 318, the method 300 ends.

As noted above, steps 312-316 are provided as only one example application of app fingerprinting. In another embodiment, the app fingerprinting may be used to help detect apps that are actually malicious computer viruses. For example, signatures of apps that are viruses may be stored. Despite the description in the file name or meta-data of a particular app, the app may be identified as an app that is a virus by comparing the binaries of the invariant features of the app with the signatures of apps that are known to be viruses. In some cases, attackers may take a legitimate app, append a malware to it and repackage the app. In turn, the attackers may put the new app (containing the malware) back to the market. Hence, the fact that two different developers having two apps with very similar signatures is a strong indicator of a malicious app. Similarly, some developers may just repackage other people's apps and then attempt to sell them as if these apps are their own apps. So, two developers having two apps with similar signatures may be used to catch these types of scenarios as well. Other applications of app fingerprinting may also be within the scope of the present disclosure.

As a result, by fingerprinting the apps, similar apps or multiple versions of the same app may be grouped together. This helps to stream line search results for apps. In addition, the fingerprinting compares signatures that include a binary subset that is generated based upon the invariant features of the apps. This provides a more accurate analysis than simply analyzing meta-data or a title. This is because the meta-data or the title of the app may be populated with whatever data a developer wants to enter, whereas the app binary cannot be manipulated.

It should be noted that although not explicitly specified, one or more steps of the method 300 described above may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step. Furthermore, operations, steps or blocks of the above described methods can be combined, separated, and/or performed in a different order from that described above, without departing from the example embodiments of the present disclosure.

FIG. 4 depicts a high-level block diagram of a general-purpose computer suitable for use in performing the functions described herein. As depicted in FIG. 4, the system 400 comprises a hardware processor element 402 (e.g., a CPU), a memory 404, e.g., random access memory (RAM) and/or read only memory (ROM), a module 405 for fingerprinting an app, and various input/output devices 406, e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

It should be noted that the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps of the above disclosed method. In one embodiment, the present module or process 405 for fingerprinting an app can be implemented as computer-executable instructions (e.g., a software program comprising computer-executable instructions) and loaded into memory 404 and executed by hardware processor 402 to implement the functions as discussed above. As such, the present method 405 for fingerprinting an app as discussed above in method 300 (including associated data structures) of the present disclosure can be stored on a non-transitory (e.g., tangible or physical) computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for fingerprinting an application, comprising:
analyzing an application binary of the application;
extracting an invariant feature from the application binary;
generating a signature from the invariant feature; and
comparing the signature of the application to a second signature of a second application to determine if the application and the second application are similar.

2. The method of claim 1, wherein the invariant feature comprises a feature that does not change between different versions of the application.

3. The method of claim 1, wherein the invariant feature comprises a call graph.

4. The method of claim 1, wherein the invariant feature comprises a memory layout.

5. The method of claim 1, wherein the invariant feature comprises a multimedia based feature.

6. The method of claim 1, wherein the signature comprises a binary subset of the application binary.

7. The method of claim 1, further comprising:
grouping the application and the second application as a single instance of a search result if the signature of the application and the second signature of the second application are similar.

8. The method of claim 1, further comprising:
listing the application and the second application as separate instances of search results if the signature of the application and the second signature of the second application are not similar.

9. The method of claim 1, wherein the application binary is automatically obtained via a web crawler.

10. A non-transitory computer-readable medium having stored thereon a plurality of instructions, the plurality of instructions including instructions which, when executed by a processor, cause the processor to perform operations for fingerprinting an application, the operations comprising:
analyzing an application binary of the application;
extracting an invariant feature from the application binary;
generating a signature from the invariant feature; and
comparing the signature of the application to a second signature of a second application to determine if the application and the second application are similar.

11. The non-transitory computer-readable medium of claim 10, wherein the invariant feature comprises a feature that does not change between different versions of the application.

12. The non-transitory computer-readable medium of claim 10, wherein the invariant feature comprises a call graph.

13. The non-transitory computer-readable medium of claim 10, wherein the invariant feature comprises a memory layout.

14. The non-transitory computer-readable medium of claim 10, wherein the invariant feature comprises a multimedia based feature.

15. The non-transitory computer-readable medium of claim 10, wherein the signature comprises a binary subset of the application binary.

16. The non-transitory computer-readable medium of claim 10, further comprising:
grouping the application and the second application as a single instance of a search result if the signature of the application and the second signature of the second application are similar.

17. The non-transitory computer-readable medium of claim 10, further comprising:
listing the application and the second application as separate instances of search results if the signature of the application and the second signature of the second application are not similar.

18. The non-transitory computer-readable medium of claim 10, wherein the application binary is automatically obtained via a web crawler.

19. An apparatus for fingerprinting an application, comprising:
a processor; and
a computer-readable medium in communication with the processor, wherein the computer-readable medium has stored thereon a plurality of instructions, the plurality of instructions including instructions which, when executed by the processor, cause the processor to perform operations, the operations comprising:
analyzing an application binary of the application;
extracting an invariant feature from the application binary;
generating a signature from the invariant feature; and
comparing the signature of the application to a second signature of a second application to determine if the application and the second application are similar.

20. The apparatus of claim 19, wherein the invariant feature comprises a feature that does not change between different versions of the application.
